(19) United States
(12) Patent Application Publication
(10) Pub. No.: US 2017/0247939 A1
(43) Pub. Date: Aug. 31, 2017

(54) A NOVEL PET DOOR APPARATUS

(71) Applicants: Nancy CARSON, San Jose, CA (US); Balcony Pets Inc., San Jose, CA (US)

(72) Inventor: Nancy Carson, San Jose, CA (US)

(21) Appl. No.: 15/513,155

(22) PCT Filed: Sep. 21, 2015
(86) PCT No.: PCT/US15/00103

§ 371 Date: Mar. 21, 2017

Related U.S. Application Data
(60) Provisional application No. 62/053,187, filed on Sep. 21, 2014.

(51) Int. Cl. E06B 7/32; E05D 15/06

(52) U.S. Cl. CPC E06B 7/32; E05D 15/06; E05Y 2900/132

(57) ABSTRACT

This disclosure pertains to a pet door apparatus, and in particular, a pet door apparatus integrated within sliding glass door frames of apartment units and other enclosed building structures. A pet door apparatus consistent with the present disclosure comprises a plurality of panels which features a flap within one of the panels. The plurality of panels are coupled to each other by at least one attachment mechanism. The coupling between the first panel and the second panel and the coupling between the second panel and the third panel forms an assembled unit. The point of coupling between at least two of the panels is adjustable to extend the length of the assembled unit. An end of one of the panels is fitted within the first track of the slidable door frame. An end of one of the other panels is fitted within the second track of the slidable door frame.

### FIELD

This disclosure pertains to a pet door apparatus, and in particular, a pet door apparatus integrated within sliding glass door frames of apartment units and other enclosed building structures.

### BACKGROUND

Many homeowners, particularly those who live in apartment units, have small pets that want to play outside. For some owners, frequently opening the sliding glass door of apartment units to let their pet in and out becomes burdensome. Therefore, a need exits for a suitable apparatus that allows pets to easily enter and exit a house, apartment, or other enclosed building structure without human assistance. The present disclosure addresses this need.

### SUMMARY

A pet door apparatus consistent with the present disclosure comprises a plurality of panels which features a flap within one of the panels. The plurality of panels are coupled to each other by at least one attachment mechanism. The coupling between the first panel and the second panel and the coupling between the second panel and the third panel forms an assembled unit. The point of coupling between at least two of the panels is adjustable to extend the length of the assembled unit. An end of one of the panels is fitted within the first track of the slidable door frame. An end of one of the other panels is fitted within the second track of the slidable door frame.

### BRIEF DESCRIPTION OF THE FIGURES

To facilitate understanding, identical reference numerals have been used, where possible, to designate identical elements that are common to the drawings. The drawings are not necessarily to scale and the relative dimensions of various elements in the drawings are depicted schematically and not necessarily to scale. The techniques of the present disclosure may readily be understood by considering the following detailed description in conjunction with the accompanying drawings, in which:

FIG. 1 is an exemplary illustration of an assembled pet door apparatus.

FIG. 2 is an exemplary illustration of a first panel with a flap on a lower end thereof.

FIG. 3 is an exemplary illustration of a second panel proximate to a first panel during assembly.

FIG. 4 is an exemplary illustration of the second panel upon assembly to the first panel.

FIG. 5 is an exemplary illustration of an assembled pet door apparatus installed within a sliding glass frame of an apartment unit.

FIG. 6 is an exemplary illustration of an assembled three-panel pet door apparatus consistent with the present disclosure.

FIG. 7 is an exploded view of a disassembled three-panel pet door apparatus consistent with the present disclosure.

A detailed description of some embodiments is provided below along with accompanying figures. The detailed description is provided in connection with such embodiments, but is not limited to any particular example. Numerous specific details are set forth in the following description in order to provide a thorough understanding. These details are provided for the purpose of example and the described techniques may be practiced according to the claims without some or all of these specific details. For the purpose of clarity, technical material that is known in the technical fields related to some embodiments has not been described in detail to avoid unnecessarily obscuring the description.

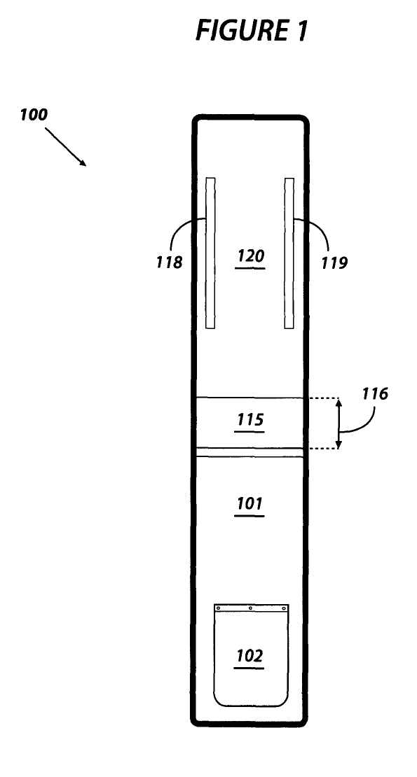

FIG. 1 is an exemplary illustration of an assembled pet door apparatus 100. Pet door apparatus 100 may be installed within the sliding glass frames of apartments, houses, and other enclosed building structures. Pet door apparatus 100 may extend from seventy to one hundred inches in some embodiments to meet the height requirements of various door frames. Pet door apparatus 100 is lightweight and weighs less than fifteen pounds and may be assembled and installed within sliding glass frames without much effort.

In some embodiments, pet door apparatus 100 includes a first panel 101 and a second panel 120 coupled together. First panel 101 and second panel 120 may be coupled together by any suitable means known in the art. For example, first panel 101 and second panel 120 may be coupled via Velcro or a dual lock fastener however the present disclosure is not limited thereto. Advantageously, the point of coupling between the first panel 101 and second panel 120 may be adjustable to extend the length of the assembled unit.

When pet door apparatus 100 is assembled, there may be on overlap 115 between the first and second panels 101, 120 a distance 116. Distance 116 may be at least eight inches according to some implementations. In addition, pet door apparatus 100 may include more than two panels 101, 120. In some embodiments, second panel 120 includes one or a plurality of attachment means to facilitate coupling with a third panel.

Most notably, first panel 101 features a flap 102 through which a pet may enter and exit there through. In some implementations, pet door apparatus 100 is fitted within the tracks of an apartment sliding door frame. In this implementation, a pet may enter and exit the apartment through flap 102 without human assistance (e.g., homeowner).

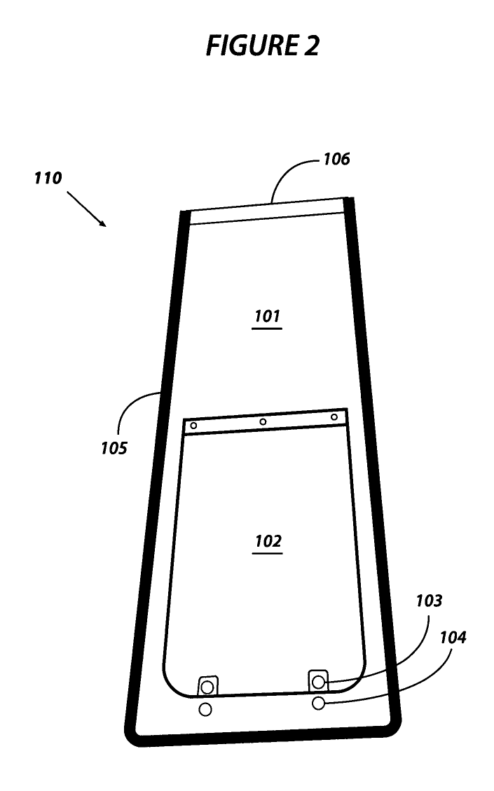

FIG. 2 is an exemplary illustration of a first panel 101 with a flap 102 on a lower end thereof. Flap 102 may include a plurality of binding posts to couple the flap 102 to the first panel 101. In addition, flap 102 may also include snap connections 103, 104 to secure the flap 102 when the pet door apparatus is not in use. Flap 102 may have a length that ranges from ten to twenty-five inches. The flap 102 may comprise any suitable material to allow a pet to easily enter and exit there through. In one embodiment, the flap 102 comprises a vinyl material.

First panel 101 may include an attachment mechanism 106 to couple the panel 101 to the second panel 102 (refer to FIG. 1). Moreover, first panel 101 along with the other panels in the apparatus 100 may have an edge seal (e.g., gasket) around the perimeter to enable the apparatus 100 to adapt to various surfaces.

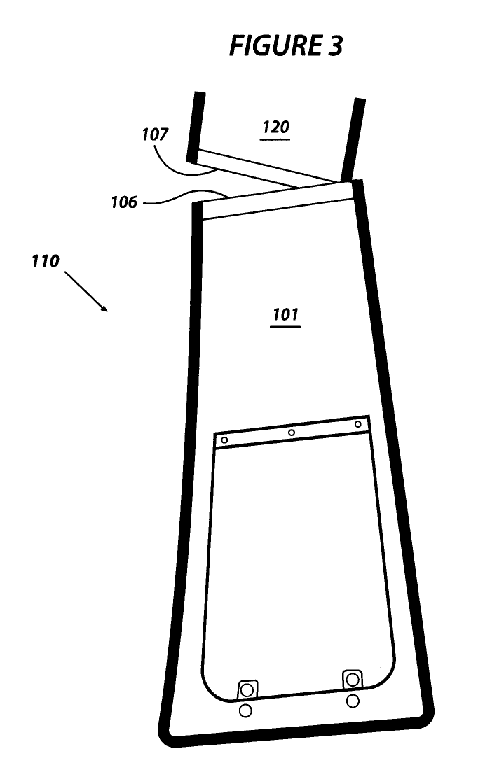

FIG. 3 is an exemplary illustration of a second panel 120 proximate to a first panel 101 during assembly. As shown, ends of the first and second panels 101, 120 are coupled together via an attachment means. In one embodiment, the attachment means are disposed horizontally along the panels 101, 120. The attachment means may include a dual lock fastener, Velcro, or any other suitable means.

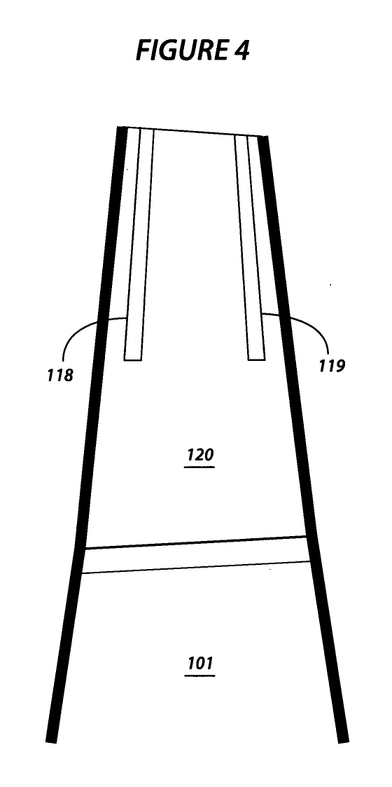

FIG. 4 is an exemplary illustration of the second panel 120 upon assembly to the first panel 101. The assembled unit should be long enough to meet the requirements of a door height. The assembled unit may have a rectangular shape. In some implementations, the first and second panels 101, 120 comprises a transparent material. For example, the first and second panels 101, 120 may comprise polycarbonate.

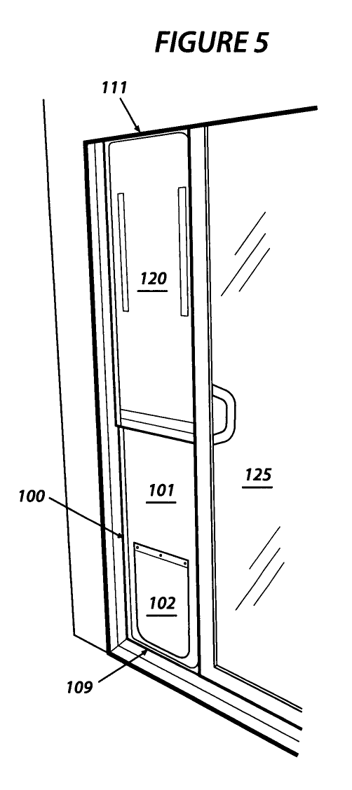

FIG. 5 is an exemplary illustration of an assembled pet door apparatus 100 installed within a sliding glass frame of an apartment unit. As shown, pet door apparatus 100 may be fitted within the tracks 109, 111 of the sliding glass frame. When assembled, the pet door apparatus 100 may be adjacent to the sliding door 125. In the embodiment shown, pet door apparatus 100 only includes two panels 101, 120. However, the present disclosure is not limited thereto and may include more than or less than two panels 101, 120. Most notably, flap 102 is disposed at a lower end of first panel 101 such that a pet can easily enter and exit the apartment unit.

The installation of the pet door apparatus 100 may still allow for an individual to utilize the screen door 125. In some implementations, the width of pet door apparatus 100 may be in the range from ten to sixteen inches. For example, the width of pet door apparatus 100 may be approximately twelve inches in some embodiments. As such, an individual may still have sufficient space to enter and exit the apartment through the sliding door while the pet door apparatus 100 is installed.

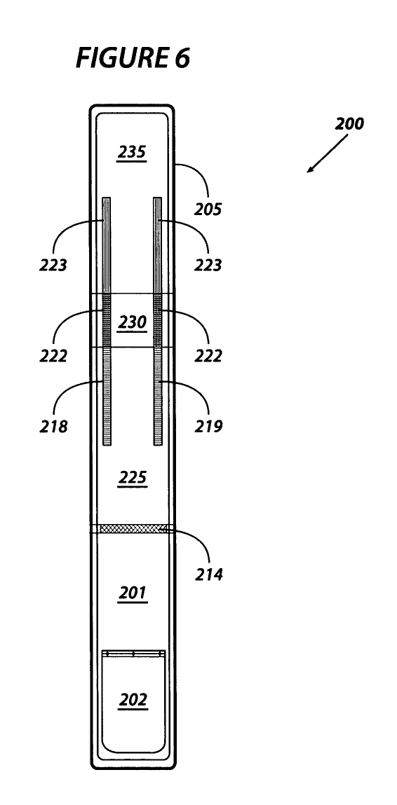

FIG. 6 is an exemplary illustration of an assembled three-panel pet door apparatus 200 consistent with the present disclosure. The pet door apparatus 200 shown includes first panel 201 (with flap 202), second panel 225, and third panel 235. Around each panel is a gasket 205. The panels may be coupled to each other by various attachment mechanisms. In some embodiments, the attachment mechanism used to couple first panel 201 to second panel 225 is different from the attachment mechanism used to couple second panel 225 to third panel 235.

The attachment mechanisms shown in FIG. 6 comprises coupling strips 214, 218, 219, 223. Coupling strips 214, 218, 219, 223 may be the same or may be different. Advantageously, coupling strips 218, 219, 223 have a length which allows the pet door apparatus 200 to have various lengths according to the height of the door frame in which the apparatus 200 will be installed. As such, there may be an overlap 230 between the assembled panels.

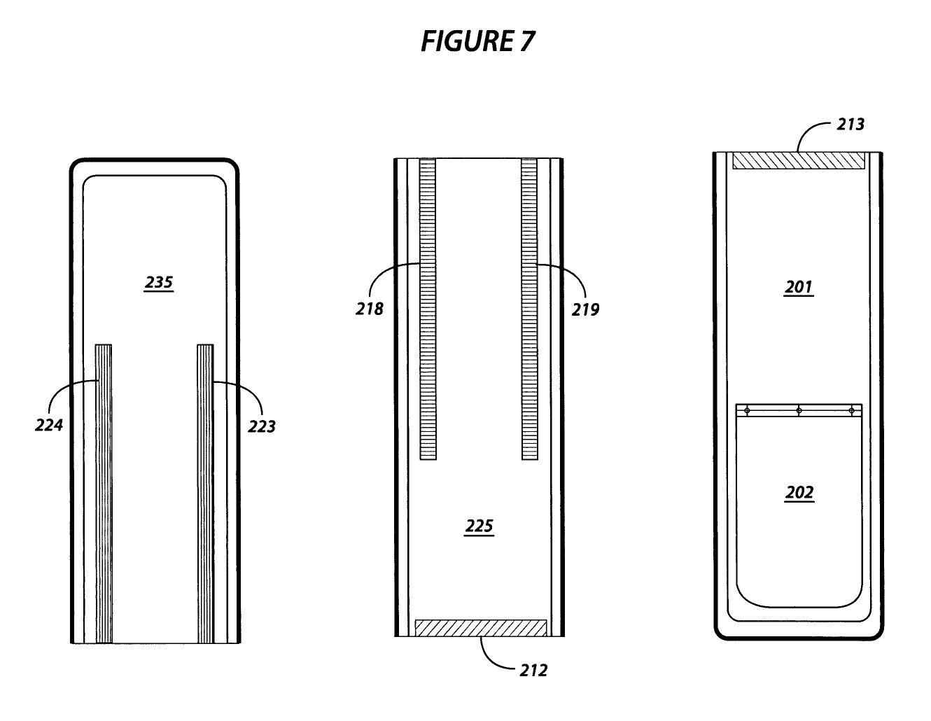

FIG. 7 is an exploded view of a disassembled three-panel pet door apparatus 200 consistent with the present disclosure. The disassembled pet door apparatus 200 has three panels, 201, 225, 235. In the embodiment shown, each panel has approximately the same dimensions (length, width). However, the present disclosure is not limited thereto. The panels 201, 225, 235 may have unique dimensions or two of the panels may have approximately the same dimensions so long as the panels 201, 225, 235 are constructed to allow for various heights for the assembled pet door apparatus 200. In some implementations, the length of each panel 201, 225, 235 is in the range of twenty to forty inches.

Panel 201 has a flap 202 which allows a pet to traverse there through. The dimensions of flap 202 may range from eight to sixteen inches in width to ten to twenty-five inches in length according to some embodiments. For example, the dimensions of flap 202 may be 9×15 inches or 12×20 inches. The dimensions of flap 202 should allow for a pet to enter or exit the pet door apparatus 200 with ease. Flap 202 may accommodate various pets, from dogs to cats of various sizes. Flap 202 may be removed from panel 201 to allow for cleaning or for the substitution of a different flap 202.

Panel 225 has attachment mechanisms 218, 219 disposed on a surface thereon to couple the panel 225 to panel 235. In addition, panel 225 has an attachment mechanism 212 to attach to attachment mechanism 213 of panel 201. Although, attachment mechanism 212 is shown as a single horizontal strip, the present disclosure is not limited thereto. In some implementations, attachment mechanism 212 may comprise a plurality of strips or a plurality of successive strip sections within a single plane.

Panel 235 has attachment mechanisms 223, 224 which aid in the coupling of the panel 235 to panel 225. Although the attachment mechanisms 223, 224 are shown to span about two-thirds of the length of the panel 235, the present disclosure is not limited thereto. Attachment mechanisms 223, 224 may span more or less than the length of the panel 235 shown. For example, attachment mechanisms 223, 224 may span the entire length of the panel. Likewise, attachment mechanisms 218, 219 of panel 225 may also span more than or less than the length of the panel 225 shown.

This disclosure pertains to pet door apparatus, and in particular, pet door apparatus integrated within sliding glass doors of apartment units. It will be understood by those having ordinary skill in the art that the present disclosure may be embodied in other specific forms without departing from the spirit and scope of the disclosure disclosed. In the examples and embodiments described herein are in all respects illustrative and not restrictive. Those skilled in the art of the present disclosure will recognize that other embodiments using the concepts described herein are also possible.

1. An apparatus, comprising:
a first member;
a flap within the first member; and
a second member coupled to an end of the first member to form an assembled unit;
wherein the point of coupling to the first member is adjustable to extend the length of the assembled unit.

2. The apparatus of claim 1, wherein the first member and the second member comprises a transparent material.

3. The apparatus of claim 1, wherein the flap is removable from the first member.

4. The apparatus of claim 1, wherein the first member and the second member each has a length between twenty-five and forty inches.

5. The apparatus of claim 1, wherein the assembled unit weighs less than fifteen pounds.

6. The apparatus of claim 1, wherein the length of the flap is between ten and twenty-five inches.

7. An apartment pet door apparatus, comprising:
a first panel;
a flap within the first panel;
a second panel coupled to the first panel by a first attachment mechanism;
a third panel coupled to the second panel by a second attachment mechanism;
wherein the point of coupling between the second panel and the third panel is adjustable to extend the length of the assembled unit;
wherein the coupling between the first panel and the second panel and the coupling between the second panel and the third panel forms an assembled unit.

8. The apartment pet door apparatus of claim 7, wherein the first attachment mechanism and the second mechanism are different.

9. The apartment pet door apparatus of claim 7, wherein the first attachment mechanism is disposed horizontally on the first panel and the second panel and the second attachment mechanism is disposed vertically on the second panel and the third panel.

10. The apartment pet door apparatus of claim 7, wherein the first panel and the second panel comprises polycarbonate.

11. The apartment pet door apparatus of claim 7, wherein the flap comprises a plurality of binding posts.

12. The apartment pet door apparatus of claim 7, wherein an edge seal is disposed around the body of the first panel, second panel, and third panel.

13. The apartment pet door apparatus of claim 7, wherein the assembled unit has a rectangular shape.

14. The apartment pet door apparatus of claim 7, wherein the flap comprises a vinyl material.

15. The apartment pet door apparatus of claim 7, wherein the first attachment mechanism comprises a snap connection.

16. A system, comprising:
a slidable door frame, comprising:
a set of tracks comprising a first track at a top portion of the slidable door frame and a second track at a bottom portion of the slidable door frame; and
an apartment pet door apparatus, comprising:
a plurality of panels;
a flap within one of the panels;
wherein the plurality of panels are coupled to each other by at least one attachment mechanism;
wherein the coupling between the first panel and the second panel and the coupling between the second panel and the third panel forms an assembled unit;
wherein the point of coupling between at least two of the panels is adjustable to extend the length of the assembled unit;
wherein an end of one of the panels is fitted within the first track of the slidable door frame and an end of one of the other panels is fitted within the second track of the slidable door frame.

17. The system of claim of 16 further comprising a sliding door fitted within the first track of the slidable door frame wherein the sliding door is adjacent to the apartment pet door apparatus.

18. The system of claim 16, wherein there is at least an eight-inch overlap between at least two of the panels.

19. The system of claim 16, wherein the length of the assembled unit ranges from seventy to one hundred inches.

20. The system of claim 16, wherein the second attachment mechanism comprises at least one dual lock fastener.
